(19) United States
(12) Patent Application Publication
(10) Pub. No.: US 2008/0140542 A1
(43) Pub. Date: Jun. 12, 2008

(54) In Application URL Re-Direction System and Method

(75) Inventor: Joseph Francis Perron, St. Michael, MN (US)

Correspondence Address: NORTH OAKS PATENT AGENCY, 45 ISLAND ROAD, NORTH OAKS, MN, 55127, US

(73) Assignee: Digital River, Inc., Eden Prairie, MN (US)

(21) Appl. No.: 11/923,055

(22) Filed: Oct. 24, 2007

Related U.S. Application Data
(60) Provisional application No. 60/864,344, filed on Nov. 3, 2006.

(51) Int. Cl. G06Q 30/00

(52) U.S. Cl. 705/27; 705/26

(57) ABSTRACT

An online web store to direct customers to a geographically appropriate e-commerce store front is described. The web store redirects customers based upon the customer's internet protocol (IP) address. For example, company “X” has two sites. One of the sites is for the Asian Pacific (APAC) region while another handles the European, Middle East, and African (EMEA) area. Within the APAC region, company “X” has a specific locale set up for the Australian continent. Company “X” would need a way to host one link on its site that would direct the user to the correct site and locale. A preferred embodiment utilizes an action handler for a link that when clicked would determine the users locale based on their IP address and redirect the user to the appropriate site and locale.

This application claims the benefit of U.S. Provisional Application No. 60/864,344 filed 3 Nov. 2006, entitled “In Application URL Redirection,” which is incorporated herein by reference.

### FIELD OF THE INVENTION

The present invention relates to a web service module that redirects customers on a web store. The invention is particularly apt for providing region based redirection of customers.

### BACKGROUND OF THE INVENTION

Utilization of the Internet continues to rise at a rapid pace. Indeed, business and governmental entities as well as individuals are increasingly relying upon the Internet for research, communication, entertainment and transactional purposes. Access to the Internet network is provided by Internet servers. Such servers are typically maintained by an Internet Service Provider (ISP) who offers “use” of its servers to customers on a pre-determined, subscription basis. Basically, an ISP is a business or organization that sells access to the internet and other related services.

In addition, a payment service provider (PSP) offers merchants online services for accepting electronic payments by credit card or other payment methods such as payments based on online banking. Typically, a PSP can connect to multiple acquiring banks and card networks, thereby making the merchant less dependent of financial institutions—especially when operating internationally. Furthermore, a PSP can offer reconciliation services, risk management and multi-currency functionality.

Along the same lines, payment gateways are a category of agent or service provider that stores, processes, and/or transmits cardholder data as part of a payment transaction. Specifically, they enable payment transactions (e.g., authorization or settlement) between merchants and processors (endpoints). Merchants may send their payment transactions directly to an endpoint, or indirectly to a payment gateway.

Access to information and movement around the Internet is enhanced through the use of hyperlinks (“links”) within a web page's hypertext markup language (HTML). The link, which is typically a word in a text field or an image on a web page, acts as a path that moves a user from one web page address, Uniform Resource Locator (URL), to another web page address on a web site. The movement from one URL to another allows near-instant access to information, products, and services and is particularly well-suited to the exchange of information, goods, and services between buyers and sellers. Such business is commonly referred to as “ecommerce,” or “electronic commerce.”

The current state of ecommerce is a state of confusion; many people are losing a great deal of money. Only few make any profit, mostly due to a poor set of products and tools. For instance, there are credit card security issues, limited ways to pay for merchandise, older browser versions, and sites that do not update their catalogs. Ecommerce web sites sell products, such as goods or services, online. They both display the products for sale and provide an easy way to complete a sales transaction. This usually involves credit card verification and automatic merchant account processing.

There are two levels of ecommerce sophistication: static and dynamic. In static, separate web pages exist for each product usually with a picture, a description, and a price. Each time the user wants to change product information they change the product's web page and upload it to the website. “Shopping Cart” functionality is a user-friendly feature and is included as standard equipment in every ecommerce hosting plan. If the user already has a website that they are happy with, and are only selling a small number of items, then a shopping cart application maybe suitable. A shopping cart enables the existing web site to take orders, and sends those orders to another application for processing. Usually, the user will have to add HTML code to the web site after every product description. (This is often referred to as “bolt-on” software.) The code will create buttons and boxes that will allow the customers to select colors, sizes and quantities, place an order, and check out. Most will allow the user to choose a design template and will then create product and category pages that already include shopping cart functions. The software generally includes a database so that adding products and updating product information requires no knowledge of HTML. The software can either be licensed outright, or rented by the month from an ASP.

In addition, there are several different ways to receive funds online. A user can travel down the time-consuming yet intellectually rewarding path of building their own shopping cart. But if the user does not have programming muscles to flex, let alone the time to build something, a web storefront service maybe the way to go. When moving currency from one party to another is involved, the time, money, and craftiness needed to implement them varies.

Just as there are bodegas and high-fashion shops, there are a wide variety of store fronts. Web stores have a more uneven quality, however. Some of the poorly managed storefronts sell non-existing merchandise; lack photos where appropriate, have a lack of customer support, have hidden payment options, and employ non-electronic payment methods. The better sites have ease of searching for content, obvious pathways through the site, and frequently updated catalogs. Furthermore, they have a way to retract purchases easily, a way to confirm purchases via email or fax, and have a way to record problems.

There is a need for an invention that will enable online web stores to redirect customers to a variety of web store sites based upon their internet protocol address. Specifically, there is a need for redirecting customers based on the region they are located and purchasing products. The present invention provides a solution to these needs and other problems, and offers other advantages over the prior art.

### BRIEF SUMMARY OF THE INVENTION

An online web store to direct customers to an appropriate ecommerce engine store front is described. The web store redirects customers based upon the customer's internet protocol (IP) address. For example, a web store for company “X” products has two or more sites. One of the sites is for the Asian Pacific (APAC) region while another handles the European, Middle East, and African (EMEA) area. Within the APAC region, the company “X” site has a specific locale set up for the Australian continent. Company “X” would need a way to host one link on its corporate site that would direct the user to the correct site and locale. Furthermore, company “X” requires different site identifications with separate accounting and separate product catalogs for its EMEA and APAC regions. In a preferred embodiment, an action handler for a link is utilized that when clicked would determine the users locale based on their IP address and redirect the user to the appropriate site and locale.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 illustrates an overview diagram of redirection module directing customers to different regional sites.

FIG. 2 shows a flow chart for a case study of an redirection module redirecting a customer using a web store.

FIG. 3 shows a screen shot of a web store utilizing the redirection module.

FIG. 4 shows another screen shot of a web store utilizing the redirection module.

FIG. 5 shows another screen shot of a web store utilizing the redirection module.

### DETAILED DESCRIPTION

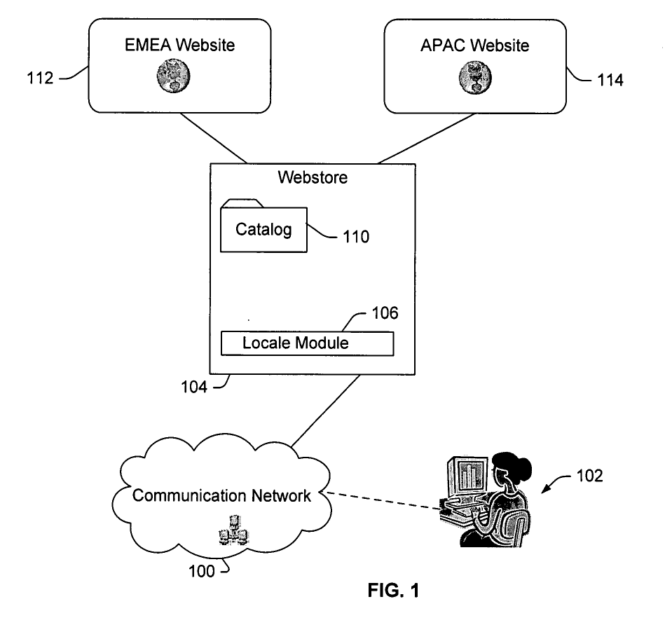

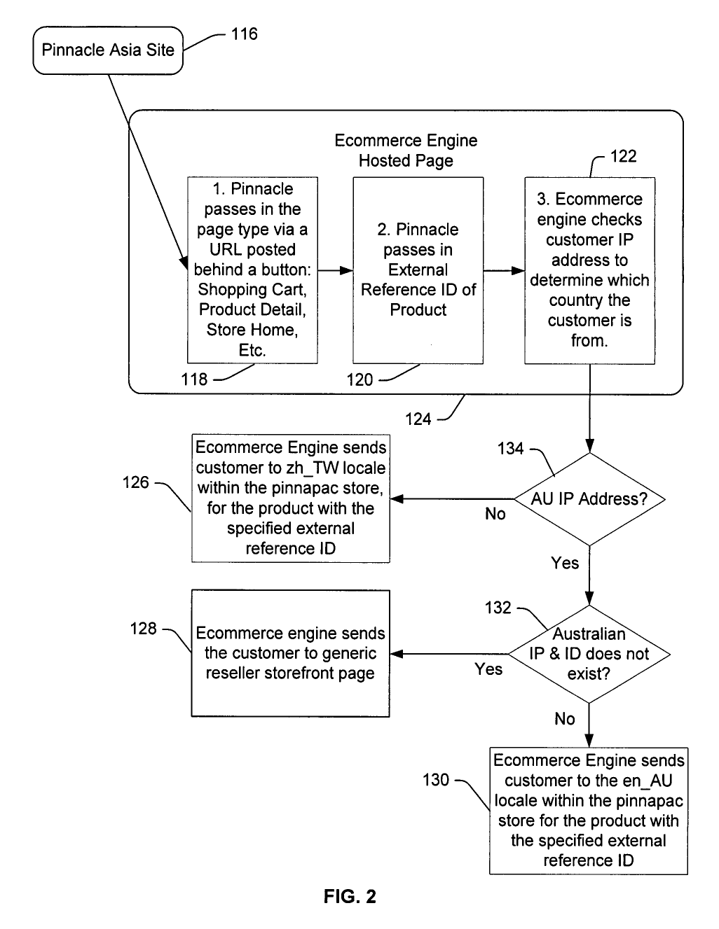

Referring now to FIG. 1, an example overview diagram is shown. In a preferred embodiment, in application URL (Uniform Resource Locator) redirection system and method enables an online web store to direct customers 102 to an appropriate ecommerce engine store front over a communication network 100. The web store redirects customers based upon the customer's internet protocol (IP) address. Web store 104 for company “X” products has two or more sites. One of the sites is for an Asian Pacific (APAC) region 114 while another handles the European, Middle East, and African (EMEA) region 112. For instance, within the APAC region 114, the company “X” site has a specific locale module 106 set up for the Australian continent. Company “X” would need a way to host one link on its corporate site that would direct the user to the correct site and locale. It will be understood by one of ordinary skill in the art that customer, user, and shopper are all synonymous terms. However, user could also be an administrator for company “X” or customer service representative. Furthermore, company “X” requires different site identifications with separate accounting and separate product catalogs 110 for its EMEA 112 and APAC 114 regions. In other words, in application URL redirection may be implemented as an action handler for a link that when clicked would determine the users locale based on their internet protocol (IP) address and redirect the user to the appropriate site and locale. In another preferred embodiment, in application URL redirection also bases the redirection on accounting and catalog details and fulfills a series of steps (shown in FIG. 2) before redirecting the customer 102.

FIG. 2 shows a flow chart for a case study of the ecommerce engine redirecting a customer using a web store. For example, company “X” is named Pinnacle, and operates a Pinnacle Asia Site 116. It will be understood by those skilled in the art that company “X” can be any company with a digital store front. An ecommerce engine hosted page 124 conducts a series of steps in order to redirect the customer within an application. It will be understood by one of ordinary skill in the art that application software is a subclass of computer software that employs the capabilities of a computer directly to a task that the user wishes to perform. This should be contrasted with system software which is involved in integrating a computer's various capabilities, but does not directly apply them in the performance of tasks that benefit the user. The term application refers to both the application software and its implementation. The features of in application URL redirection can also be applied to redirection of web pages.

Referring again to FIG. 2, in a preferred embodiment, Pinnacle passes in a page type via a URL posted behind a button (such as Shopping Cart, Product Detail, Store Home, etc.). This is shown in step 118. Next, Pinnacle passes in an external reference identification (ID) of a product, as shown in step 120. Third, the ecommerce engine checks a customer IP address to determine which country the customer is located. This is step 122. Then the next step is based on the answer to two questions. First, is the IP address for Australia? (Decision 134). If yes, the second question is whether an ID does not exist (Decision 132). If no at decision step 134, the ecommerce engine sends 126 the customer to zh_TW locale within the Pinnacle store for the specified external reference ID. Additionally, at decision step 132, if the answer is yes, the ecommerce engine routes 128 the customer to a generic reseller page. Routing 128 means that there is an Australian IP but there is no external reference ID. Furthermore, if the answer at decision 132 is no, then the ecommerce engine sends 130 the customer to an en_AU locale within the Pinnacle store for the product with the specified external reference ID.

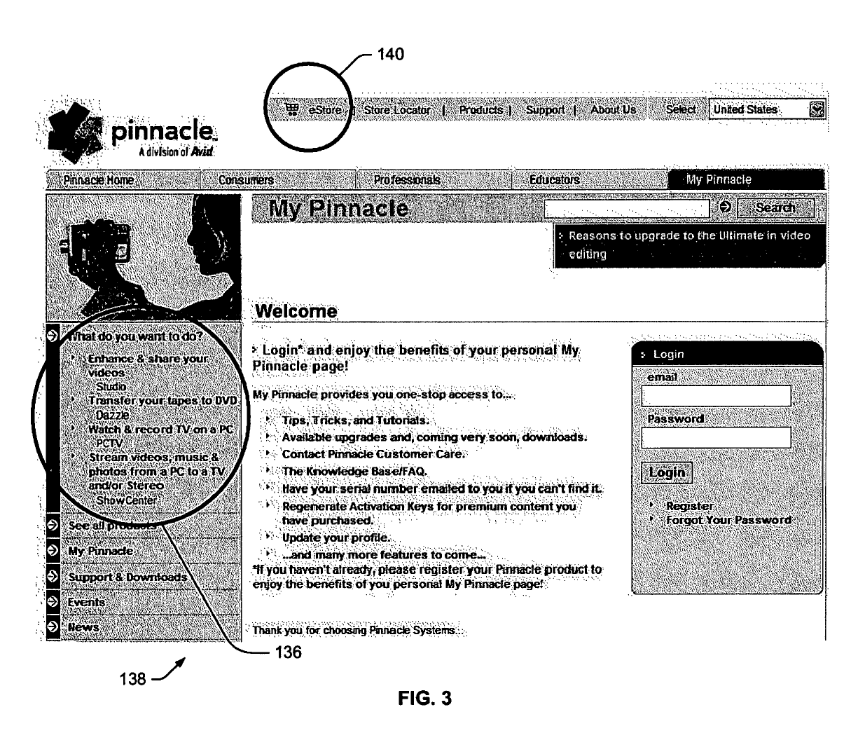

Furthermore, FIG. 3 shows a screen shot of a page 138 from which the customer may be redirected to or redirected from. By means of example, company “X” will be called Pinnacle. It will be understood by those skilled in the art that company “X” can be any company with a digital store front. As seen in FIG. 3, while on the Pinnacle Asia site the customer may access the store by either clicking on the “eStore” button 140 in the top navigation bar, or by navigating through the Pinnacle hosted product pages 136. Pinnacle will then pass the page type through the URL (such as store home, product detail, shopping cart, etc.) Pinnacle will then pass the External Reference ID through the URL.

The e-commerce engine will detect the customer's IP address, and direct the customer to either the Australian locale within the pinnacle store or the International English locale within a piestore store. It will be understood by those skilled in the art that site identifications (ID) are how one system tells one site from another. For example, the site ID titled “pinnapac” could be the site for the Pinnacle APAC store and the site ID titled “piestore” could be the Pinnacle international English store.

It will also be understood by one of ordinary skill in the art that web services exist today which provide reverse IP address lookups that determine a user's geographic location based on the IP network address of the user's computer. For example, a company named Digital Envoy which has offices at 250 Scientific Drive, Suite 800, Norcross, Ga. 30092 provides such a reverse IP lookup web service named NetAcuity. A phone home function for a registered software license would use the IP address of a user's computer at the time of a phone home operation to determine the present country location of the user's computer and compare that present country location with the country limitation of the registered software license. In addition, a storefront could use a customer provided billing country in tandem with a reverse IP lookup determined country for a user's computer to define the country for which that license is available. It will be appreciated by those skilled in the art that many different country-based license policies could be defined regarding the license validation and any acceptable exceptions to the license policies.

In another preferred embodiment, the external reference ID will map to the appropriate product ID in either the piestore or pinnapac catalog. Thereafter, links to shopping cart, store home, and product detail pages will update to the appropriate store based on the IP of the user. In addition, Pinnacle may require different Site ID's with separate accounting and separate product catalogs for their EMEA and APAC regions. In that case, Pinnacle will not have a separate Australian site that would direct customers directly to the Australian store. They will have one Asia site, from which customers need to be directed to the appropriate store (piestore or pinnapac), based on the customer's IP address. Because there will be two stores with different product catalogs (piestore and pinnapac), identical products will exist in each catalog, each with a different e-commerce engine product identification (ID). Since Pinnacle will only have one Asia site, it will only have one “buy button”, which needs to point to the appropriate product in either catalog. Since there are two different product IDs, it will need Pinnacle to point to a specific value that can be consistent for a specific product that exists in each catalog (External Reference ID may be that value).

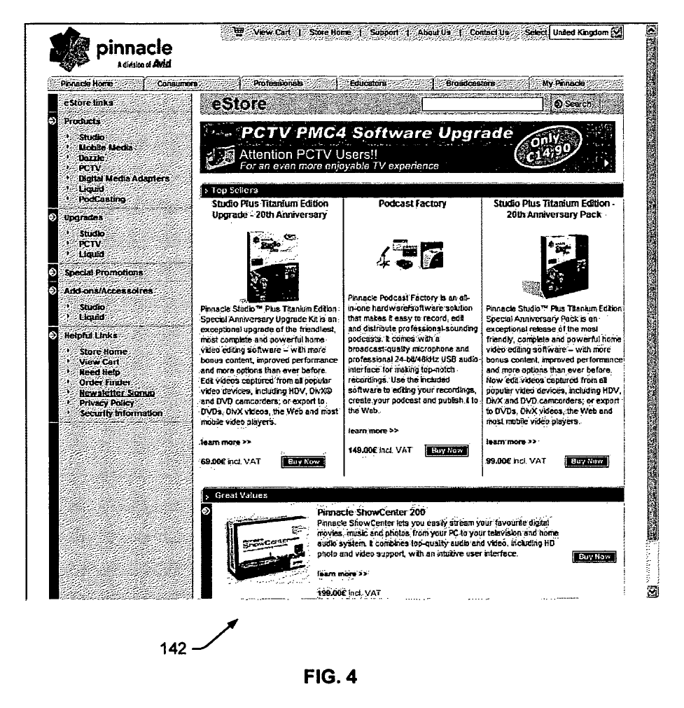

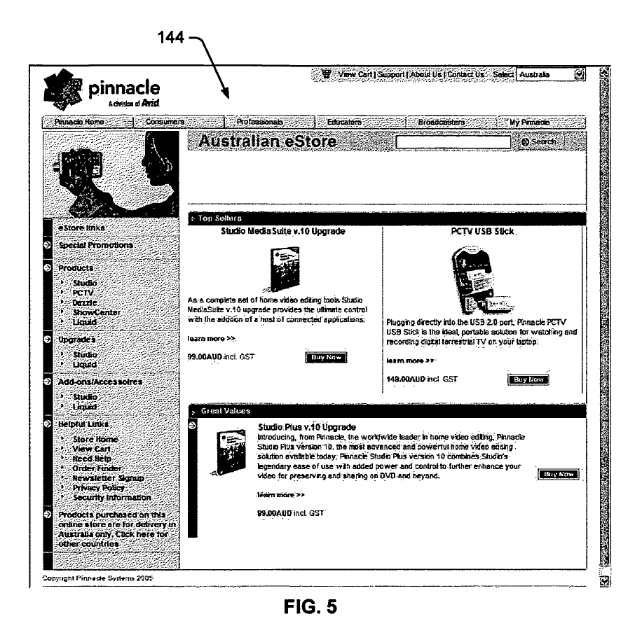

FIGS. 4 and 5 are further screen shots (142 and 144) of what a customer may view during redirection while shopping and surfing on a Pinnacle site. It will be understood by those skilled in the art that a “locale” is made of a language and country designation. The first two letters are the language and the second two are the country. For example, the locale of “zh_TW” would be Chinese language and Taiwan country. Also, the locale of “en_AU” would be English language and Australian country.

Users in Australia (AU) will be directed to the pinnapac store with a locale of en_AU. Users in AU who do not have a valid product ID/external reference ID may be redirected to http://www.pinnaclesys.com/PublicSite/as/Purchase/Store+Locator. Users not located in AU but that have a valid product ID/external reference ID will be redirected to the site piestore with a locale of zh_TW. Users not in AU and do not have a valid product ID/external reference ID will also be redirected to the site piestore with a locale of zh_TW.

In another preferred embodiment, the customer would make a selection, or click, on an existing URL link. The system would then make a new URL link based upon parameters of the existing URL link. These URL parameters can also be URL content. The customer is then redirected to this new URL. Page data can also be utilized while redirecting to the new URL. Page data is page type information, such as home page, landing page, catalog page, etc. It will be understood by one of ordinary skill in the art that page data can be any number of page type information.

Furthermore, when the customer makes a selection they are usually within a software application. It will be understood by one of ordinary skill in the art that the software application could be a webstore, real-time synchronized catalogs, software games, email programs, email, data programs, spreadsheet programs, spreadsheets, and any other application that requires user input. The information (whether it be page data, IP information, external reference IDs, etc) is passed from the software application to the ecommerce business webservice or system. There the new URL link is created for redirection purposes.

Pinnacle (or any other store front) would not have a separate Australian site that would direct customers directly to the Australian store. They would have one Asia site, from which customers need to be directed to the appropriate store (piestore or pinnapac), based on the customer's IP address. Moreover, because there are two stores with different product catalogs (piestore and pinnapac), identical products will exist in each catalog, each with a different ecommerce engine site.

Customers with a non-Australian IP address will be directed to the product with the specific external reference ID in the International English (zh_TW) locale of the piestore store. Customers with an Australian IP address will be directed to the product with the specific external reference ID in the Australian (en_AU) locale of the pinnapac store. In addition, customers with an Australian IP address but with a non-existing external reference ID in the pinnapac product catalog will be directed to a generic Pinnacle Reseller page (See FIG. 2). In another embodiment, the locale module, catalog data, accounting data, and user data site identification codes are all used in conjunction to redirect the customer to a particular region.

It will be understood that additional locales such as Japan, China, Korea, and other countries may be detected as well. The IP detection process is a flexible process that can be continually updated. For example, if an ecommerce engine recognizes a Japanese IP address, the customer may be sent to the Japanese locale for the product within the pinnapac product catalog with the External Reference ID that Pinnacle is specifying. In other words, this will not be built specific for Australia only.

Table 1 (shown below) outlines sample code that may be utilized to implement a preferred embodiment of the invention. Furthermore, Table 2 (also shown below) shows definitions that are intended to clarify terms and concepts used within this document.

### Business Requirements

The company “X” passes the ecommerce engine the page type that they want the customer to end upon (store home, product detail, shopping cart, etc.)

Company “X” passes the e-commerce engine the External Reference ID of the product the customer is purchasing. This can be a company product part number, or something unique to the e-commerce engine system.

The External Reference ID will be installed on identical products within each catalog (piestore and pinnapac). For example, a product called “Studio 10” in the piestore catalog will have the same External Reference ID as “Studio 10” in the pinnapac catalog.

No two products within a catalog (piestore or pinnapac) will have the same External Reference ID. If a product is duplicated for a promotion, it will be given a different External Reference ID.

The e-commerce engine checks the customer's IP address and sends the customer to the appropriate locale within either the piestore or pinnapac store, based on the specific External Reference ID of the product the customer is intending to purchase.

TABLE 1
Sample Code

```
import java.util.Iterator;
import java.util.Locale;
import com.digitalriver.catalog.Catalog;
import com.digitalriver.catalog.CatalogModule;
import com.digitalriver.catalog.Product;
import com.digitalriver.site.Site;
import com.digitalriver.site.SiteModule;
import com.digitalriver.system.Application;
import com.digitalriver.system.controller.ControllerUtil;
import com.digitalriver.user.UserSession;
import com.digitalriver.util.StringUtil;
public rule DisplayIPBasedLandingPage( ) {
  // sample request link:
http://store.digitalriver.com/store/pinnapac/en_AU/
DisplayCustomLandingPage/pageType.shoppingCart/
externalRefID.12345678
    CatalogModule catModule =
Application.getModule(CatalogModule.NAME);
  SiteModule siteModule = Application.getModule(SiteModule.NAME);
  UserSession sess = UserSession.getSession( );
  String companyID = sess.getUser( ).getCompanyID( );
  String countryCode = sess.getPersonum( ).getConvCtryCode( );
  String externalRefID = request.getParameter(“externalRefID”);
  String pageType = request.getParameter(“pageType”);
    if(StringUtil.equals(“AU”, countryCode.toUpperCase( ))) {
    //user is in AU
  Product product =
catModule.getProductByExternalReference(externalRefID, “pinnapac”);
  if(product != null){
    // product is in catalog, continue on to pinnapac store
    if(pageType.toLowerCase( ).equals(“shoppingcart”)){
      // add new productID to request
      request.setAttribute(“productID”, product.getProductID( ));
      request.setAttribute(“quantity”, “1”);
      // add item to requisition
      com.digitalriver.catalog.rules.AddItemToRequisition( );
      // go to shopping cart page
      controller.setNextPage(“ShoppingCartPage”);
    }else if(pageType.toLowerCase( ).equals(“storehome”)){
      controller.setNextPage(“HomePage”);
    }else if(pageType.toLowerCase( ).equals(“product”)){
      // add new productID to request
      request.setAttribute(“productID”, product.getProductID( ));
      // go to product details page
      controller.setNextPage(“ProductDetailsPage”);
        }else{
      // if above page type checks fail, go to home page
      controller.setNextPage(“HomePage”);
    }
  }else{
    // send user to reseller page
response.sendRedirect(“http://www.pinnaclesys.com/PublicSite/as/
Purchase/Store+Locator”);
  }
    }else{
      // user is not in AU, send to piestore
  Site piestore = siteModule.getSite(“piestore”);
  // check products on piestore for match to passed in externalRefID
  Product product2 =
catModule.getProductByExternalReference(externalRefID, “piestore”);
  StringBuffer urlBuf = StringBuffer.class.newInstance( );
    urlBuf.append(“DRHM/servlet/ControllerServlet?”);
  // now build redirect to piestore
  if(product2 != null){
    if(pageType.toLowerCase( ).equals(“shoppingcart”)){
      // go to shopping cart page
urlBuf.append(controller.-
buildRequiredURLParameters(“AddItemToRequisition”,
piestore.getSiteID( ) , “zh_TW”));
      urlBuf.append(“&”);
        urlBuf.append(“productID”);
        urlBuf.append(“=”);
      urlBuf.append(product2.getProductID( ));
      }else if(pageType.toLowerCase( ).equals(“product”)){
urlBuf.append(controller.buildRequiredURLParameters(“DisplayProduct
DetailsPage”, piestore.getSiteID( ) , “zh_TW”));
        urlBuf.append(“&”);
          urlBuf.append(“productID”);
          urlBuf.append(“=”);
        urlBuf.append(product2.getProductID( ));
      }else{
        // if above page type checks fail, go to home page
urlBuf.append(controller.-
buildRequiredURLParameters(“DisplayStoreHomePage”,
piestore.getSiteID( ) , “zh_TW”));
      }
  }else{
    // if above page type checks fail, go to home page
urlBuf.append(controller.-
buildRequiredURLParameters(“DisplayStoreHomePage”,
piestore.getSiteID( ) , “zh_TW”));
  }
    prefix = “http://estore.pinnaclesys.com/”;
  // send to piestore
    response.sendRedirect(prefix + urlBuf.toString( ));
```

TABLE 2
Commonly used terms

| Term | Definition |
|---|---|
| External | A field or value within an e-commerce system. Specific |
| Reference ID | products across both product catalogs (piestore and |
| (ExtRefID) | pinnapac) will have identical ExtRefID's. For example, |
| | a product called Studio 10 will exist in both the piestore |
| | and pinnapac product catalogs, and will have the same |
| | ExtRefID. ExtRefID can be the same as the Pinnacle |
| | part number, or a unique naming convention for the e- |
| | commerce system. |
| piestore and | piestore is a Pinnacle EMEA store that is hosted by an |
| pinnapac | e-commerce engine. It has several different locales. |
| | pinnapac is a Pinnacle APAC store that is hosted by an |
| | ecommerce engine. |

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the web interface such that different communication protocols may be organized or designed differently while maintaining substantially the same functionality and without departing from the scope and spirit of the present invention.

What is claimed is:

1. A web service configured to utilize a customer's internet protocol (IP) address, user data site identification codes, and a locale to redirect the customers to an appropriate electronic commerce store front.

2. The web service of claim 1 wherein the customer is redirected to the appropriate electronic commerce store front by making a selection within a software application chosen from a group consisting of: webstore, real-time synchronized catalogs, software games, email programs, email, data programs, spreadsheet programs, spreadsheets, and any other application that requires user input.

3. A method for redirecting customers to an electronic commerce (ecommerce) store front comprising steps of:
receiving a current internet protocol (IP) address of the local computer over a communication link;
determining the current geographic location for the received current IP address by performing a reverse IP address lookup in a geographic location cross reference to the IP address database; and
redirecting the customer to a locale specific electronic commerce store front based upon the determined current geographic location.

4. The method of claim 3 further comprising an ecommerce engine that is operatively configured to analyze a combination of at least two of the following:
the IP address, the locale, and catalog information to determine the appropriate electronic commerce store front.

5. The method of claim 3 wherein the redirecting step further includes passing page type data from a software application to the ecommerce system.

6. The method of claim 5 wherein the software application is chosen from a group consisting of: webstore, real-time synchronized catalogs, software games, email programs, email, data programs, spreadsheet programs, spreadsheets, and any other application that requires user input.

7. The method of claim 3 wherein the redirecting step further includes analyzing an existing Uniform Resource Locator (URL) link to determine URL content information such that a new URL link is created.

8. A method for redirecting customers to an electronic commerce (ecommerce) store front comprising steps of:
receiving an external reference identification (ID) of a product;
receiving a current internet protocol (IP) address of the local computer over a communication link;
determining the current geographic location for the received current IP address by performing a reverse IP address lookup in a geographic location cross reference to the IP address database;
redirecting the customer to a locale specific electronic commerce store front based upon the determined current geographic location.

9. The method of claim 8 wherein the redirecting step further includes rerouting customer to a generic storefront page if the external reference ID is not available.

10. The method of claim 8 wherein the redirecting step further includes passing page type data from a software application to the ecommerce system.

11. The method of claim 10 wherein the software application is chosen from a group consisting of: webstore, real-time synchronized catalogs, software games, email programs, email, data programs, spreadsheet programs, spreadsheets, and any other application that requires user input.

12. The method of claim 8 wherein the redirecting step further includes analyzing an existing Uniform Resource Locator (URL) link to determine URL content information such that a new URL link is created.
